(19) United States
(12) Patent Application Publication
(10) Pub. No.: US 2017/0116791 A1
(43) Pub. Date: Apr. 27, 2017

(54) METHOD, AND ELECTRONIC DEVICE FOR ADJUSTING VEHICLE INFORMATION

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Hailan YU, Tianjin (CN); Qin HUANG, Tianjin (CN)

(21) Appl. No.: 15/243,810

(22) Filed: Aug. 22, 2016

Related U.S. Application Data
(63) Continuation of application No. PCT/CN2016/087016, filed on Jun. 24, 2016.

(30) Foreign Application Priority Data
Oct. 22, 2015 (CN) 201510694425.1

(51) Int. Cl. G07C 5/00

(52) U.S. Cl. CPC G07C 5/008; H04W 4/008

(57) ABSTRACT

An embodiment of the present disclosure discloses a method, an apparatus and a system for adjusting vehicle information, wherein the method comprises: discovering, by a mobile end, various service information supported by a vehicle end and characteristics corresponding to the various service information by scanning Universally Unique Identifiers (UUIDs) broadcast by the vehicle end; receiving from the vehicle end and storing, by the mobile end, the characteristics with vehicle information which is an indication of the characteristics; and if the mobile end's established connection with the vehicle end changes, sending, by the changed mobile end pre-saved vehicle information to the vehicle end, so that the vehicle end adjusts current vehicle information according to the received vehicle information. The embodiments of the present disclosure free users from adjusting vehicle information manually, reduces preparation work before driving a vehicle and saves time and energy.

### CROSS-REFERENCE TO RELATED APPLICATIONS

The present disclosure is a continuation of International Application No. PCT/CN2016/087016, filed on Jun. 24, 2016; which is based upon and claims priority to Chinese Patent Application No. 201510694425.1, entitled “METHOD, AND ELECTRONIC DEVICE FOR ADJUSTING VEHICLE INFORMATION”, filed on Oct. 22, 2015, the entire contents of all of which are incorporated herein by reference.

### TECHNICAL FIELD

The present disclosure generally relates to the field of automobile technology, and particularly relates to an apparatus, a method and a system for adjusting vehicle information.

### BACKGROUND

Automobiles have gradually become popularized in people's life with the development of technology and the economy. Generally, there is only one family car in each family, and several family members take turns using it.

Since each individual has a different body size and driving habits from others, the positions of the vehicle seat and the steering wheel need to be adjusted according to personal circumstances and vehicle information such as vehicle light color is also adjusted according to personal preference before driving.

If the driver changes, vehicle information such as the positions of the vehicle seat and the steering wheel needs to be re-adjusted. Although some vehicles are configured with a function like adjusting the vehicle seat electrically, it takes a certain amount of time and energy to adjust the vehicle information such as positions of the vehicle seat and steering wheel to an appropriate state.

Although the drivers of a family car such as only a few family members are relatively fixed, adjusting the vehicle information manually frequently still increases the steps of preparation work before driving.

### SUMMARY

An embodiment of the present disclosure discloses a method, an apparatus and a system for adjusting vehicle information, to solve the problem of complicated operations and therefore time and energy consumption for adjusting vehicle information when the driver of the car changes.

An embodiment of the present disclosure discloses a method for adjusting vehicle information, including:

discovering various service information supported by a vehicle end and characteristics corresponding to the various service information by scanning Universally Unique Identifiers (UUIDs) broadcast by the vehicle end, by a mobile end;

receiving characteristics with vehicle information from the vehicle end and saving the characteristics with vehicle information, by the mobile end, wherein the vehicle information is an indication of the characteristics; and

if the mobile end which establishes connection with the vehicle end changes, sending pre-saved vehicle information to the vehicle end, by the changed mobile end, so that the vehicle end adjusts current vehicle information according to the received vehicle information.

An embodiment of the present disclosure further discloses an electronic device for adjusting vehicle information, including:

at least one first processor; and a memory communicably connected with the at least one first processor for storing instructions executable by the at least one first processor, wherein execution of the instructions by the at least one first processor causes the at least one first processor to:

discover various service information supported by a vehicle end and characteristics corresponding to the various service information by scanning Universally Unique Identifiers (UUIDs) broadcast by the vehicle end, by the electronic device;

receive characteristics with vehicle information from the vehicle end and saving the characteristics with vehicle information, by the electronic device, wherein the vehicle information is an indication of the characteristics; and

if the electronic device which establishes connection with the vehicle end changes, send pre-saved vehicle information to the vehicle end, so that the vehicle end adjusts current information according to the received vehicle information.

An embodiment of the present disclosure further discloses an electronic device for adjusting vehicle information, including:

at least one second processor and a second memory communicably connected with the at least one second processor for storing instructions executable by the at least one second processor, wherein execution of the instructions by the at least one second processor causes the at least one second processor to:

broadcast Universally Unique Identifiers (UUIDs) of various service information supported by the electronic device;

collect vehicle information, and determine the collected vehicle information as an indication of characteristics corresponding to the various service information;

send the collected vehicle information to a mobile end when the mobile end discovers the various service information supported by the electronic device and the characteristics corresponding to the various service information by scanning the Universally Unique Identifiers (UUIDs) broadcast by the electronic device;

receive, if the mobile end which establishes connection with the electronic device changes, vehicle information pre-saved in the changed mobile end; and

adjust current vehicle information according to the received vehicle information.

An embodiment of the present disclosure discloses a system for adjusting vehicle information, including: a mobile end and a vehicle end, wherein: the mobile end includes an apparatus for adjusting vehicle information described in the embodiment of the present disclosure; and the vehicle end includes another apparatus for adjusting vehicle information described in the embodiment of the present disclosure.

An embodiment of the present disclosure discloses a computer readable storage medium recorded with a program for executing the method described in the embodiment of the present disclosure thereon.

With the method and system for adjusting vehicle information disclosed by the embodiments of the present disclosure, the vehicle end may collect vehicle information adjusted by each user and send the collected vehicle information to the mobile end of the user for saving. In particular, the vehicle end may broadest Universally Unique Identifiers (UUIDs), and the mobile end scans the UUIDs to discover the service information supported by the vehicle end and the characteristics corresponding to the service information. Vehicle information may be stored in the characteristics corresponding to the service information, when the user changes, i.e., when the mobile end's established connection with the vehicle end changes, the changed mobile end sends pre-saved vehicle information to the vehicle end, and the vehicle end adjusts the current vehicle information according to the received vehicle information. This allows the users to avoid adjusting the vehicle information manually, reduces the preparation work before driving a vehicle, and saves time and energy.

### BRIEF DESCRIPTION OF THE DRAWINGS

In order to more clearly illustrate the technical solutions in the embodiments of the present disclosure, the drawings required to be used in the description of the embodiments will be briefly introduced in the following; it is obvious that the drawings described in the following are only related to some embodiments of the present disclosure. Other drawings may be obtained according to these drawings by those ordinarily skilled in the art without engaging in creative work.

FIG. 1 is a step flow chart of a method for adjusting vehicle information according to an embodiment of the present disclosure.

FIG. 2 is a step flow chart of a method for adjusting vehicle information according to another embodiment of the present disclosure.

FIG. 3 is a macro logic flowchart of a method for adjusting vehicle information according to still another embodiment of the present disclosure.

FIG. 4 is a diagram of a scenario where a method for adjusting vehicle information according to a further embodiment of the present disclosure is applied.

FIG. 5 is a schematic structural diagram of a system for adjusting vehicle information according to an embodiment of the present disclosure.

FIG. 6 is a schematic structural diagram of a system for adjusting vehicle information according to another embodiment of the present disclosure.

FIG. 7 is a block diagram of an electronic device for executing the method according to the present disclosure.

FIG. 8 is a storage unit for maintaining or carrying a program code for realizing the method according to the present disclosure.

### DETAILED DESCRIPTION

For the purpose of making objects, technical solutions and advantages of embodiments of the present disclosure more clear, clear and complete descriptions will be made to technical solutions of the present disclosure in conjunction with the corresponding drawings in the embodiments of the present disclosure. Obviously, the described embodiments are merely a part of the embodiments of the present disclosure and not all the embodiments. Based on the embodiments of the present disclosure, all other embodiments obtained by those ordinarily skilled in the art without creative work fall within the protection scope of the present disclosure.

### First Embodiment

A method for adjusting vehicle information disclosed in the first embodiment of the present disclosure will be described in detail.

The embodiment involves a vehicle end and a mobile end, where the vehicle end collects vehicle information; and the mobile end receives the vehicle information from the vehicle end.

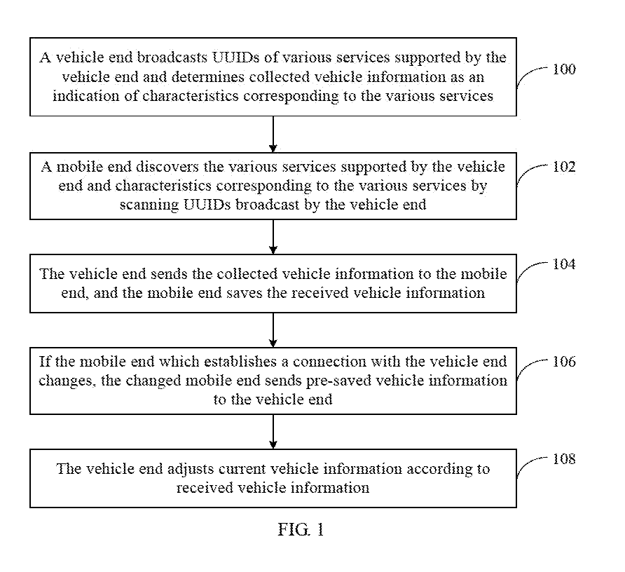

With reference to FIG. 1, a step flow chart of a method for adjusting vehicle information according to an embodiment of the present disclosure is shown.

Step 100: a vehicle end broadcasts UUIDs of various service information supported by the vehicle end and determines collected vehicle information as an indication of characteristics corresponding to the various service information.

In the embodiment, the service information supported by the vehicle end may include: vehicle seat and Steering Wheel Service information, Vehicle Light Service information, and Device Information Service information, etc.

Each kind of service information has its own UUID, and each UUID is different from each other.

Each kind of service information also has its own characteristics, for example, the characteristics of the Vehicle Seat and Steering Wheel Service are the Vehicle Seat and Steering Wheel Service Characteristics; the characteristics of the Vehicle Light Service are the Vehicle Light Service Characteristics; and the characteristics of the Device Information Service are the Device Information Service Characteristics.

The indication of the characteristics is vehicle information, and the vehicle information of the embodiment may include: vehicle seat and steering wheel position data, and vehicle light color data, etc.

There is a correspondence between specific vehicle information and the indication of the characteristics of specific service information. For example, the vehicle seat and steering wheel position data corresponds to the indication of Vehicle Seat and Steering Wheel Service Characteristics of the Vehicle Seat and Steering Wheel Service; and the vehicle light color data corresponds to the indication of the Vehicle Light Service Characteristics of the Vehicle Light Service.

Step 102: the mobile end discovers various service information supported by the vehicle end and characteristics corresponding to the various service information by scanning the UUIDs broadcast by the vehicle end.

The supporting relations of the various service information supported by the mobile end and the vehicle end as well as of the characteristics corresponding to the various service information are shown in Table 1.

TABLE 1

| Configuration information | Support |
|---|---|
| Service discovery | M |
| Vehicle Seat and Steering Wheel Service discovery | M |
| Vehicle Light Service discovery | M |
| Device Information Service discovery | O |
| Characteristics discovery | M |
| Vehicle Seat and Steering Wheel Service | M |
| Characteristics discovery | |
| Vehicle Light Service Characteristics discovery | M |
| Device Information Service Characteristics discovery | O |
| Position Measurement | M |
| Light Color Record | M |

In the above Table 1, M stands for Mandatory, and O stands for Optional.

The mobile end discovers the service information by UUIDs of the service information. That is, the mobile end discovers the Vehicle Seat and Steering Wheel Service, Vehicle Light Service and Device Information Service by the UUIDs of the Vehicle Seat and Steering Wheel Service, Vehicle Light Service and Device Information Service.

The mobile end discovers the characteristics of the service information and indications of the characteristics by UUIDs of the service information. That is, the mobile end discovers the characteristics of the Vehicle Seat and Steering Wheel Service, the characteristics of the Vehicle Light Service and the characteristics of the Device Information Service as well as respective indications thereof (configuration descriptors of the characteristics) by the UUIDs of the Vehicle Seat and Steering Wheel Service, Vehicle Light Service and Device Information Service.

Step 104: the vehicle end sends the collected vehicle information to the mobile end, and the mobile end saves the received vehicle information.

The vehicle information collected by the vehicle end is vehicle information generated after adjusting the vehicle information by each user, where the users may include a driver and a secondary driver.

If the vehicle end collects the vehicle information adjusted by the driver, it sends the collected vehicle information to the mobile end corresponding to the driver; if the vehicle end collects the vehicle information adjusted by the secondary driver, it sends the collected vehicle information to the mobile end corresponding to the secondary driver.

Each mobile end only saves vehicle information adjusted by its corresponding user.

Step 106: if the mobile end which establishes connection with the vehicle end changes, the changed mobile end sends pre-saved vehicle information to the vehicle end.

The connection between the vehicle end and the mobile end is established via a low-power-consumption Bluetooth, and the vehicle end may only connect with one mobile end at a time. When a certain mobile end disconnects with the mobile end and another mobile end establishes a connection with the vehicle end, i.e., when the mobile end which establishes connection with the vehicle end changes, the changed mobile end sends pre-saved vehicle information to the vehicle end.

For example, when the mobile end of user A disconnects with the vehicle end and the mobile end of user B establishes a connection with the vehicle end, the mobile end of user B sends the pre-saved vehicle information adjusted by user B to the vehicle end.

Step 108: the vehicle end adjusts the current vehicle information according to the received vehicle information.

Continuing the above example, the current vehicle information is vehicle information adjusted by user A. The vehicle end adjusts the current vehicle information, according to the received vehicle information adjusted by user B, to be the vehicle information adjusted by user B.

In view of the foregoing, with the technical solution in the embodiment of the present disclosure, the vehicle end may collect vehicle information adjusted by each user and send the collected vehicle information to the mobile end of the user for saving. In particular, the vehicle end may broadcast UUIDs, the mobile end scans the UUIDs to discover service information supported by the vehicle end as well as characteristics corresponding to the service information. Vehicle information may be stored in the characteristics corresponding to the service information. When the user changes, i.e., when the mobile end which establishes connection with the vehicle end changes, the changed mobile end sends pre-saved vehicle information to the vehicle end, and the vehicle end adjusts the current vehicle information according to the received vehicle information. This avoids adjusting vehicle information by the users manually, reduces preparation work before driving a vehicle and saves time and energy.

### Second Embodiment

A method for adjusting vehicle information disclosed in the second embodiment of the present disclosure will be described in detail.

The embodiment involves a vehicle end and a mobile end, where the vehicle end collects vehicle information; and the mobile end receives the vehicle information from the vehicle end.

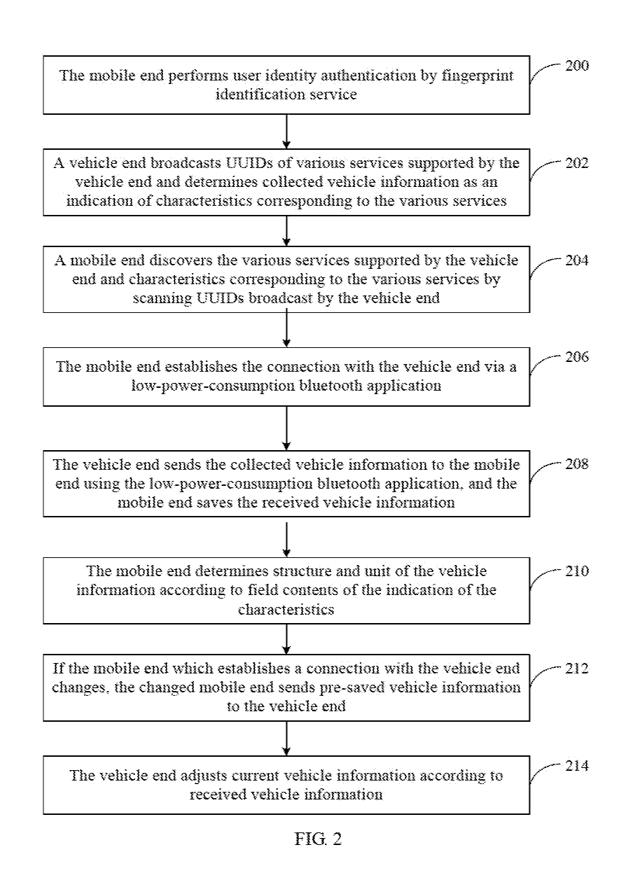

With reference to FIG. 2, a step flow chart of a method for adjusting vehicle information in the second embodiment of the present disclosure is shown.

Step 200: the mobile end performs user identity certification with fingerprint identification service information, and if the certification is passed, step 202 is executed; and if the certification fails, then the process ends.

Step 202: the vehicle end broadcasts the UUIDs of various service information supported by the vehicle end and determines the collected vehicle information as an indication of the characteristics corresponding to the various service information.

In the embodiment, the service information supported by the vehicle end may include: Vehicle Seat and Steering Wheel Service information, Vehicle Light Service information, and Device Information Service information, etc.

Each kind of service information has its own UUID, and each UUID is different from each other.

Each kind of service information also has its own characteristics, for example, the characteristics of the Vehicle Seat and Steering Wheel Service are the Vehicle Seat and Steering Wheel Service Characteristics; the characteristics of the Vehicle Light Service are the Vehicle Light Service Characteristics; and the characteristics of the Device Information Service are the Device Information Service Characteristics.

The indication of the characteristics is vehicle information, and the vehicle information of the embodiment may include: vehicle seat and steering wheel position data, and vehicle light color data, etc.

There is a correspondence between specific vehicle information and the indication of the characteristics of specific service information. For example, the vehicle seat and steering wheel position data corresponds to the indication of the Vehicle Seat and Steering Wheel Service Characteristics of the Vehicle Seat and Steering Wheel Service; and the vehicle light color data corresponds to the indication of the Vehicle Light Service Characteristics of the Vehicle Light Service.

Step 204: the mobile end discovers various service information supported by the vehicle end and characteristics corresponding to the various service information by scanning the UUIDs broadcast by the vehicle end.

The mobile end discovers the service information by the UUIDs of the service information. That is, the mobile end discovers the Vehicle Seat and Steering Wheel Service, Vehicle Light Service and Device Information Service by the UUIDs of the Vehicle Seat and Steering Wheel Service, Vehicle Light Service and Device Information Service.

The mobile end discovers the characteristics of the service information and indications of the characteristics by the UUIDs of the service information. That is, the mobile end discovers the characteristics of the Vehicle Seat and Steering Wheel Service, the characteristics of the Vehicle Light Service and the characteristics of the Device Information Service as well as the respective indications thereof (configuration descriptors of the characteristics) by the UUIDs of the Vehicle Seat and Steering Wheel Service, Vehicle Light Service and Device Information Service.

Step 206: the mobile end establishes a connection with the vehicle end via a low-power-consumption Bluetooth application.

The connection between the vehicle end and the mobile end is established via a low-power-consumption Bluetooth application, and the vehicle end may only connect with one mobile end at a time.

Step 208: the vehicle end sends collected vehicle information to the mobile end via the low-power-consumption Bluetooth application, and the mobile end saves the received vehicle information.

The vehicle information collected by the vehicle end is vehicle information generated after adjusting of the vehicle information by each user, where the users may include a driver and a secondary driver.

If the vehicle end collects the vehicle information adjusted by the driver, it sends the collected vehicle information to the mobile end corresponding to the driver; if the vehicle end collects the vehicle information adjusted by the secondary driver, it sends the collected vehicle information to the mobile end corresponding to the secondary driver.

Each mobile end only saves vehicle information adjusted by its corresponding user.

Step 210: the mobile end determines a structure and a unit of the vehicle information according to content in the field of the indication of the characteristics.

Different content in the field in the indication of the characteristics may represent different structures and units of vehicle information.

Step 212: if the mobile end which establishes connection with the vehicle end changes, the changed mobile end sends pre-saved vehicle information to the vehicle end.

When a certain mobile end disconnects with the vehicle end and another mobile end establishes a connection with the vehicle end, i.e., when the mobile end which establishes connection with the vehicle end changes, the changed mobile end sends pre-saved vehicle information to the vehicle end.

For example, when the mobile end of user A disconnects with the vehicle end and the mobile end of user B establishes a connection with the vehicle end, then the mobile end of user B sends the pre-saved vehicle information adjusted by user B to the vehicle end.

Step 214, the vehicle end adjusts the current vehicle information according to the received vehicle information.

Continuing the above example, the current vehicle information is vehicle information adjusted by user A. The vehicle end adjusts the current vehicle information, according to the received vehicle information adjusted by user B, to be the vehicle information adjusted by user B.

To improve the user experience, the vehicle end may contain a local name in the broadcast data or the scanning response data. And, the mobile end may define the name of the vehicle end.

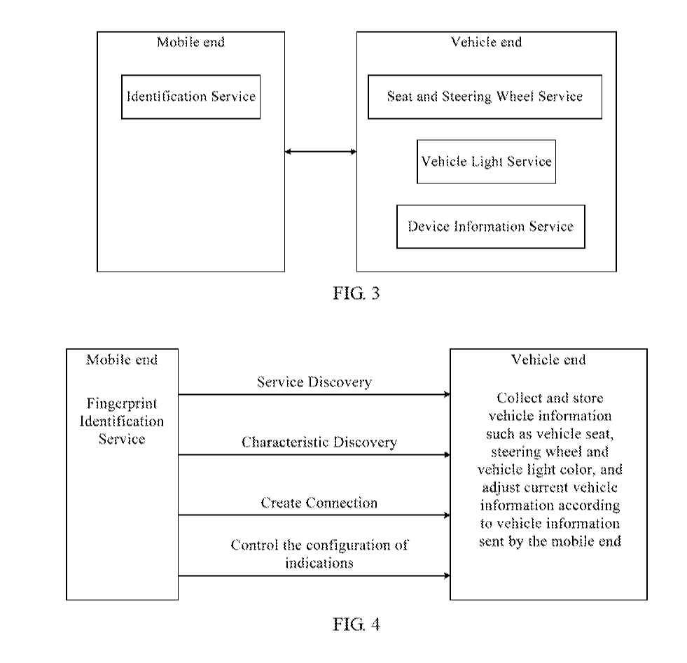

A macro logic flow chart of a method for adjusting vehicle information disclosed by the embodiment of the present disclosure is shown as FIG. 3. Data interaction is performed between the mobile end and the vehicle end, the mobile end is provided with fingerprint Identification Service information, and the vehicle end is provided with a Vehicle Seat and Steering Wheel Service, Vehicle Light Service and Device Information Service.

A method for adjusting vehicle information disclosed by the embodiment may be applied to a scenario shown in FIG. 4. The mobile end interacts with the vehicle end by Service Discovery, Characteristics Discovery, creating a connection and controlling the configuration of indications, to achieve adjustment of the vehicle information. The mobile end is provided with fingerprint identification service information, and the vehicle end may collect and store vehicle information such as vehicle seat, steering wheel and vehicle light color and adjust current vehicle information according to the vehicle information sent by the mobile end. For example, a family car is co-used by a male owner and a female owner.

Step 1: the male owner sits in the driver's seat and his identity is confirmed by fingerprint identification on his mobile end and is informed to the vehicle end, and then the male owner starts adjusting the vehicle seat and steering wheel position and interior light color and the like in a way that suits him.

Step 2: the mobile end of the male owner automatically collects the data such as the vehicle seat and steering wheel position and interior light color and saves the record.

Step 3: the female owner sits in the driver's seat and her identity is confirmed by fingerprint identification on her mobile end and is informed to the vehicle end, and then the female owner starts adjusting the vehicle seat and steering wheel position and vehicle light color and the like in a way that suits her.

Step 4: the mobile end of the female owner automatically collects the data such as the vehicle seat and steering wheel position and vehicle light color and saves the records.

Step 5: the male owner sits in the driver's seat again, and his identity is confirmed by fingerprint identification on his mobile end and is informed to the vehicle end, and then the vehicle end adjusts current seat and steering wheel, vehicle light color and the like according to the vehicle information sent by the mobile end of the mail owner.

Step 6: the female owner sits in the driver's seat again, and her identity is confirmed by fingerprint identification on her mobile end and is informed the vehicle end, and then the vehicle end adjusts current seat and steering wheel, vehicle light color and the like according to the vehicle information sent by the mobile end of the female owner.

In view of the foregoing, with the technical solution in the embodiment of the present disclosure, the vehicle end may collect vehicle information adjusted by each user and send the collected vehicle information to the mobile end of the user for saving. In particular, the vehicle end may broadcast UUIDs, the mobile end scans the UUIDs to discover service information supported by the vehicle end as well as characteristics corresponding to the service information. Vehicle information may be stored in the characteristics corresponding to the service information. When the user changes, i.e., when the mobile end which establishes connection with the vehicle changes, the changed mobile end sends pre-saved vehicle information to the vehicle end, and the vehicle end adjusts the current vehicle information according to the received vehicle information. This avoid adjusting vehicle information by the users manually, reduces preparation work before driving a vehicle and saves time and energy.

### Third Embodiment

A system for adjusting vehicle information disclosed in the third embodiment of the present disclosure will be described in detail.

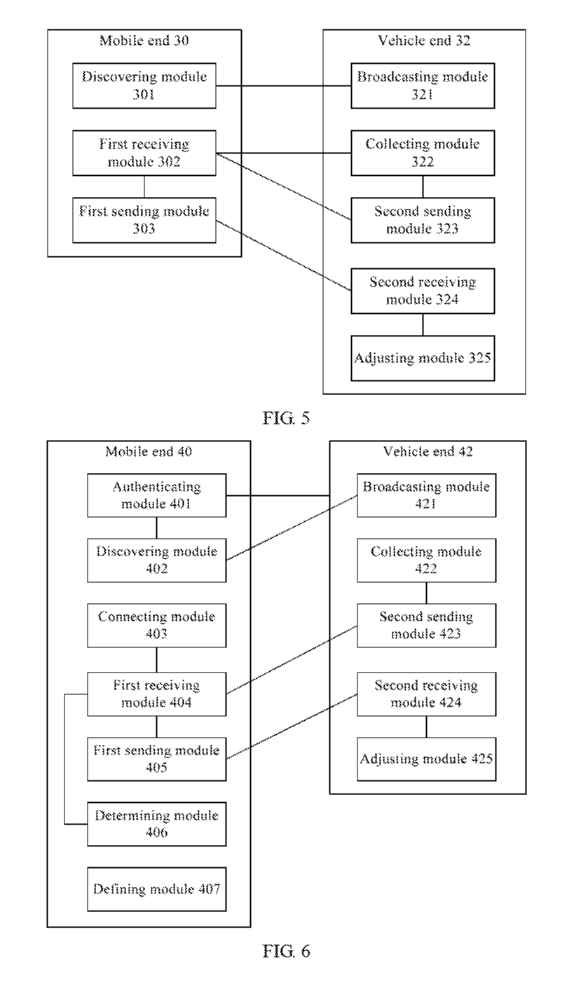

With reference to FIG. 5, a schematic structural diagram of a system for adjusting vehicle information in the third embodiment of the present disclosure is shown.

The system may include: a mobile end 30 and a vehicle end 32.

Where, an apparatus for adjusting vehicle information may be applied to the mobile end 30, and the apparatus for adjusting vehicle information applied to the mobile end may include: a discovering module 301, a first receiving module 302 and a first sending module 303.

Another apparatus for adjusting vehicle information may be applied to the vehicle end 32, and the apparatus for adjusting vehicle information applied to the vehicle end may include: a broadcasting module 321, a collecting module 322, a second sending module 323, a second receiving module 324 and an adjusting module 325.

The function of each module and relations among the modules will be given a detailed description hereinafter.

The discovering module 301 is configured to discover various service information supported by the vehicle end and characteristics corresponding to the various service information by scanning Universally Unique Identifiers (UUIDs) broadcast by the vehicle end.

The first receiving module 302 is configured to receive and save the characteristics with vehicle information which is an indication of the characteristics, from the vehicle end.

If the mobile end which establishes connection with the vehicle end changes, a first sending module 303 of the changed mobile end is configured to send pre-saved vehicle information to the vehicle end, so that the vehicle end adjusts current information according to the received vehicle information.

The broadcasting module 321 is configured to broadcast Universally Unique Identifiers (UUIDs) of various service information supported by the vehicle end.

The collecting module 322 is configured to collect vehicle information, and determine the collected vehicle information as an indication of characteristics corresponding to the various service information.

The second sending module 323 is configured to send the collected vehicle information to the mobile end when the mobile end discovers the various service information supported by the vehicle end and the characteristics corresponding to the various service information by scanning the UUIDs broadcast by the vehicle end.

The second receiving module 324 is configured to receive, if the mobile end which establishes connection with the vehicle end changes, vehicle information pre-saved in the changed mobile end.

The adjusting module 325 is configured to adjust current vehicle information according to the received vehicle information.

In view of the foregoing, with the technical solution in the embodiment of the present disclosure, the vehicle end may collect vehicle information adjusted by each user and send the collected vehicle information to the mobile end of the user for saving. In particular, the vehicle end may broadcast UUIDs, the mobile end scans the UUIDs to discover service information supported by the vehicle end, as well as characteristics corresponding to the service information. Vehicle information may be stored in the characteristics corresponding to the service information. When the user changes, i.e., when the mobile end which establishes connection with the vehicle changes, the changed mobile end sends pre-saved vehicle information to the vehicle end, and the vehicle end adjusts the current vehicle information according to the received vehicle information. This avoid adjusting vehicle information manually by the users, reduces preparation work before driving a vehicle and saves time and energy.

### Fourth Embodiment

A system for adjusting vehicle information disclosed by the fourth embodiment will be described in detail.

With reference to FIG. 6, a schematic structural diagram of a system for adjusting vehicle information in the fourth embodiment of the present disclosure is shown.

The system may include: a mobile end 40 and a vehicle end 42.

Where, an apparatus for adjusting vehicle information may be applied to the mobile end 40, and the apparatus for adjusting vehicle information applied to the mobile end includes: a certificating module 401, a discovering module 402, a connecting module 403, a first receiving module 404, a first sending module 405, a determining module 406 and a defining module 407.

Another apparatus for adjusting vehicle information may be applied to the vehicle end 42, and the apparatus for adjusting vehicle information applied to the vehicle end includes: a broadcasting module 421, a collecting module 422, a second sending module 423, a second receiving module 424 and an adjusting module 425.

The function of each module and relations among the modules will be given detailed description hereinafter.

The certificating module 401 is configured to perform, before the discovering module 402 discovers various service information supported by the vehicle end and characteristics corresponding to the various service information by scanning Universally Unique Identifiers (UUIDs) broadcast by the vehicle end, user identity certification with fingerprint identification service information; if the certification is passed, the discovering module 402 discovers the various service information supported by the vehicle end and characteristics corresponding to the various service information by scanning the Universally Unique Identifiers (UUIDs) broadcast by the vehicle end.

The discovering module 402 is configured to discover various service information supported by the vehicle end and characteristics corresponding to the various service information by scanning Universally Unique Identifiers (UUIDs) broadcast by the vehicle end.

The connecting module 403 is configured to establish, before the first receiving module 404 receives and saves the characteristics with the vehicle information from the vehicle end, a connection with the vehicle end via a low-power-consumption Bluetooth application.

The first receiving module 404 is configured to receive and store the characteristics with vehicle information which is an indication of the characteristics, from the vehicle end.

Preferably, the first receiving module 404 receives and saves the characteristics stored with the vehicle information, from the vehicle end using the low-power-consumption Bluetooth application.

If the mobile end which establishes connection with the vehicle end changes, a first sending module 405 of the changed mobile end is configured to send pre-saved vehicle information to the vehicle end, so that the vehicle end adjusts current information according to the received vehicle information.

The determining module 406 is configured to determine, after the first receiving module 404 receives and saves the characteristics with the vehicle information from the vehicle end, a structure and a unit of the vehicle information according to content in the field of the indication of the characteristics.

The defining module 407 is configured to define a name of the vehicle end.

The broadcasting module 421 is configured to broadcast Universally Unique Identifiers (UUIDs) of various service information supported by the vehicle end.

The collecting module 422 is configured to collect vehicle information, and determine the collected vehicle information as an indication of characteristics corresponding to the various service information.

The second sending module 423 is configured to send the collected vehicle information to a mobile end, when the mobile end discovers various service information supported by the vehicle end and characteristics corresponding to the various service information by scanning the Universally Unique Identifiers (UUIDs) broadcast by the vehicle end.

The second receiving module 424 is configured to receive, if the mobile end which establishes connection with the vehicle end changes, vehicle information pre-saved in the changed mobile end.

The adjusting module 425 is configured to adjust current vehicle information according to the received vehicle information.

In view of the foregoing, with the technical solution in the embodiment of the present disclosure, the vehicle end may collect vehicle information adjusted by each user and send the collected vehicle information to the mobile end of the user for saving. In particular, the vehicle end may broadcast UUIDs, the mobile end scans the UUIDs to discover service information supported by the vehicle end as well as characteristics corresponding to the service information. Vehicle information may be stored in the characteristics corresponding to the service information. When the user changes, i.e., when the mobile end which establishes connection with the vehicle end changes, the changed mobile end sends pre-saved vehicle information to the vehicle end, and the vehicle end adjusts the current vehicle information according to the received vehicle information. This avoid adjusting vehicle information manually by the users, reduces preparation work before driving a vehicle and saves time and energy.

Apparatus embodiments described above are illustrative only, wherein the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. Those ordinarily skilled in the art may understand and implement it without paying creative works.

Apparatuses of the present disclosure may be achieved with hardware, or with software modules run on one or more processors, or with a combination thereof. Those skilled in the art should appreciate some or all functions of some or all parts in the communication processing device of embodiments of the present disclosure may be achieved using a microprocessor or Digital Signal Processor (DSP) in practice. The present disclosure may also achieve a device or apparatus program (e.g., computer program and computer program product) for executing some or all of the methods described herein. Such program for achieving the present disclosure may be stored on a computer readable medium or may have a form of one or more signals. Such signal may be downloaded from internet websites, or provided on a carrier signal, or provided in any other form.

For example, apparatuses of the present disclosure may be used in an electronic device, which may traditionally include a processor and computer program product in a form of memory or a computer readable medium. The memory may be an electronic memory such as a flash memory, EEPROM (Electrically Erasable Programmable Read-Only Memory), EPROM (Electrically Programmable Read-Only Memory), hard disk or ROM (Read-Only Memory). The memory has storage space for program codes for executing any step of the above-mentioned method. For example, the storage space for program codes may include each program code for achieving every step of the above method. These program codes may be read from or write into one or more computer program products. These computer program products include program code carrier such as hard disk, Compact Disk (CD), memory card or floppy disk. Such computer program product is generally a portable or fixed storage unit, and the storage unit may have memory segment, storage space and the like with an arrangement similar to that of the memory of the above-mentioned computing device. The program code may be compressed in an appropriate form. Generally, the storage unit includes computer readable codes, i.e., codes that may be read by for example the above-mentioned processor, and when these codes are run by the computing device, it causes the computing device to execute each step of the above-described method.

Those ordinarily skilled in the art may appreciate that: all or part of the steps of the above-mentioned method embodiments may be achieved by hardware related to program instructions, the aforesaid program may be stored in a computer readable storage medium, and when the program is executed, steps including the above-mentioned method embodiments are executed; and the aforesaid storage medium includes various media that may store program codes such as ROM, RAM, diskette or optical disk, etc.

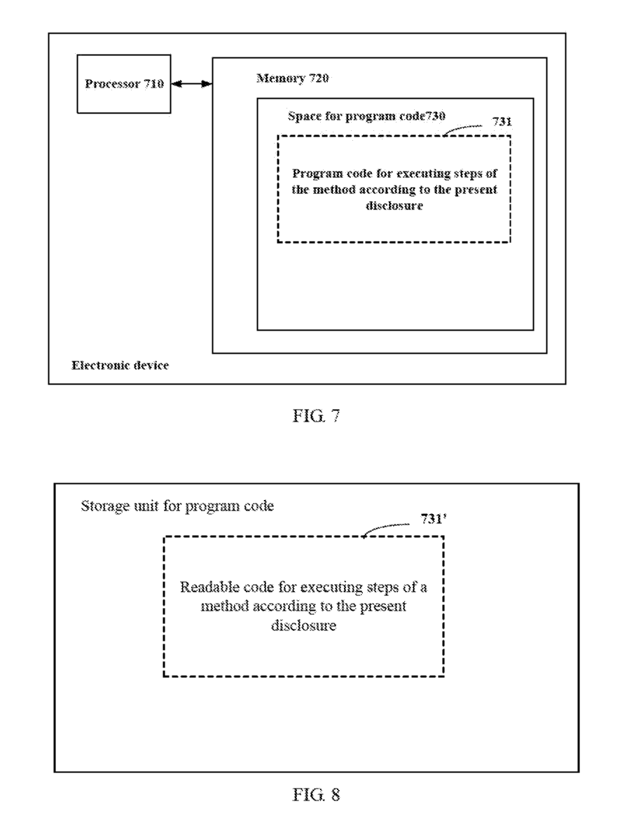

FIG. 7 shows an electronic device that may achieve the method for adjusting vehicle according to the present disclosure. The electronic device may be the mobile end or the vehicle end above, which traditionally includes a processor 710 and a module (program) product in form of memory 720 or a readable medium. The memory 720 may be an electronic memory such as a flash memory, EEPROM (Electrically Erasable Programmable Read-Only Memory), EPROM, or ROM. The memory 720 has storage space 730 for program code 731 which is used for executing any step of the above-mentioned method. For example, the storage space 730 for program code may include program codes 731 for achieving various steps of the above method. Such program codes may be read from or write into one or more computer program product. These program products include a program code carrier such as memory card. Such program product is generally a portable or fixed storage unit as shown in FIG. 8. The storage unit may have memory segment, storage space and the like with an arrangement similar to that of the memory 720 of the electronic device in FIG. 7. The program code may be compressed in an appropriate form. Generally, the storage unit includes a computer readable code 731′, i.e., a code that may be read by a processor like the processor 710, and when these codes are run by the processor of the electronic device, it causes the processor of the electronic device to execute each step of the above-described method.

Finally, it should be noted that the foregoing embodiments are merely illustrative of technical solutions of the present disclosure without limitation; although the present disclosure is illustrated in detail with reference to the above embodiments, those ordinarily skilled in the art will appreciate that modifications may be made on the technical solutions cited by the above embodiments, or equivalent substitutions may be made on partial technical features; moreover, these modifications or substitutions will not make the essential of corresponding technical solutions depart from the spirit and scope of the technical solutions in respective embodiments of the present disclosure.

What is claimed is:

1. A method for adjusting vehicle information, comprising:
discovering various service information supported by a vehicle end and characteristics corresponding to the various service information by scanning Universally Unique Identifiers (UUIDs) broadcast by the vehicle end, by a mobile end;
receiving characteristics with vehicle information from the vehicle end and saving the characteristics with vehicle information, by the mobile end, wherein the vehicle information is an indication of the characteristics; and
if the mobile end which establishes connection with the vehicle end changes, sending pre-saved vehicle information to the vehicle end, by the changed mobile end, so that the vehicle end adjusts current vehicle information according to the received vehicle information.

2. The method according to claim 1, wherein the various service information comprises: vehicle seat and steering wheel service information, vehicle light service information and device information service information.

3. The method according to claim 1, wherein the vehicle information comprises: vehicle seat and steering wheel position data, and vehicle light color data.

4. The method according to claim 1, wherein before the mobile end receiving the characteristics with vehicle information from the vehicle end and saving the characteristics with vehicle information, by the mobile end, the method further comprising:
establishing a connection with the vehicle end via a low-power-consumption Bluetooth application, by the mobile end.

5. The method according to claim 4, wherein receiving the characteristics with vehicle information from the vehicle end and saving the characteristics with vehicle information, by the mobile end comprising:
receiving characteristics with the vehicle information from the vehicle end and storing characteristics with the vehicle information using the low-power-consumption Bluetooth application, by the mobile end.

6. The method according to claim 1, wherein after receiving the characteristics with vehicle information from the vehicle end and saving the characteristics with vehicle information, by the mobile end, the method further comprising:
determining a structure and a unit of the vehicle information according to content in the field of the indication of the characteristics, by the mobile end.

7. The method according to claim 1, wherein before discovering the various service information supported by the vehicle end and characteristics corresponding to the various service information by scanning the Universally Unique Identifiers (UUIDs) broadcast by the vehicle end, by the mobile end, the method further comprising:
performing user identity certification with fingerprint identification service information, by the mobile end; wherein if the certification is passed, the operation of discovering the various service information supported by the vehicle end and characteristics corresponding to the various service information by scanning the Universally Unique Identifiers (UUIDs) broadcast by the vehicle end is executed.

8. The method according to claim 1, further comprising:
defining a name of the vehicle end, by the mobile end.

9. An electronic device for adjusting vehicle information, comprising:
at least one first processor; and
a memory communicably connected with the at least one first processor for storing instructions executable by the at least one first processor, wherein execution of the instructions by the at least one first processor causes the at least one first processor to:
discover various service information supported by a vehicle end and characteristics corresponding to the various service information by scanning Universally Unique Identifiers (UUIDs) broadcast by the vehicle end, by the electronic device;
receive characteristics with vehicle information from the vehicle end and saving the characteristics with vehicle information, by the electronic device, wherein the vehicle information is an indication of the characteristics; and
if the electronic device which establishes connection with the vehicle end changes, send pre-saved vehicle information to the vehicle end, so that the vehicle end adjusts current information according to the received vehicle information.

10. The electronic device according to claim 9, wherein, the various service information comprises: vehicle seat and steering wheel service information, vehicle light service information and device information service information.

11. The electronic device according to claim 9, wherein, the vehicle information comprises: vehicle seat and steering wheel position data, and vehicle light color data.

12. The electronic device according to claim 9, wherein, execution of the instructions by the at least one first processor causes the at least one first processor to further:
before the first receiving module receives the characteristics with vehicle information from the vehicle end and saves the characteristics stored with the vehicle information by the electronic device, establish a connection with the vehicle end via a low-power-consumption Bluetooth application by the electronic device.

13. The electronic device according to claim 12, wherein, the electronic device receives, characteristics with the vehicle information from the vehicle end and stores characteristics with the vehicle information using the low-power-consumption Bluetooth application.

14. The electronic device according to claim 9, wherein, execution of the instructions by the at least one first processor causes the at least one first processor to further:
determine, after the first receiving module receives the characteristics with the vehicle information from the vehicle end and saves the characteristics with the vehicle information, a structure and a unit of the vehicle information according to content in the field of the indication of the characteristics.

15. The electronic device according to claim 9, wherein, execution of the instructions by the at least one first processor causes the at least one first processor to further:
before discovering the various service information supported by the vehicle end and the characteristics corresponding to the various service information by scanning the Universally Unique Identifiers (UUIDs) broadcast by the vehicle end, perform user identity certification with fingerprint identification service information; wherein if the certification is passed, the operation of discovering the various service information supported by the vehicle end and the characteristics corresponding to the various service information by scanning the Universally Unique Identifiers (UUIDs) broadcast by the vehicle end is executed.

16. The electronic device according to claim 9, wherein, execution of the instructions by the at least one first processor causes the at least one first processor to further:
define a name of the vehicle end.

17. An electronic device for adjusting vehicle information, comprises:
at least one second processor, and
a second memory communicably connected with the at least one second processor for storing instructions executable by the at least one second processor, wherein execution of the instructions by the at least one second processor causes the at least one second processor to:
broadcast Universally Unique Identifiers (UUIDs) of various service information supported by the electronic device;
collect vehicle information, and determine the collected vehicle information as an indication of characteristics corresponding to the various service information;
send the collected vehicle information to a mobile end when the mobile end discovers the various service information supported by the electronic device and the characteristics corresponding to the various service information by scanning the Universally Unique Identifiers (UUIDs) broadcast by the electronic device;
receive, if the mobile end which establishes connection with the electronic device changes, vehicle information pre-saved in the changed mobile end; and
adjust current vehicle information according to the received vehicle information.
